(19) United States
(12) Patent Application Publication
(10) Pub. No.: US 2019/0176325 A1
(43) Pub. Date: Jun. 13, 2019

(54) An Error Modeling Method For End-Effector Space-Curve Trajectory Of Six Degree-of-Freedom Robots

(71) Applicant: Beijing University of Technology, Beijing (CN)

(72) Inventors: Zhifeng Liu, Beijing (CN); Jingjing Xu, Beijing (CN); Yongsheng Zhao, Beijing (CN); Caixia Zhang, Beijing (CN); Qiang Cheng, Beijing (CN); Yanhu Pei, Beijing (US)

(73) Assignee: Beijing University of Technology, Beijing (CN)

(21) Appl. No.: 16/311,182

(22) PCT Filed: Sep. 25, 2017
(86) PCT No.: PCT/CN2017/103080

§ 371 Date: Dec. 19, 2018

(30) Foreign Application Priority Data
Apr. 9, 2017 (CN) 201710226520.8

(51) Int. Cl. B25J 9/16

(52) U.S. Cl. CPC B25J 9/1605; B25J 9/1664; B25J 9/1653

(57) ABSTRACT

The invention disclosed an error modeling method for six degree-of-freedom robot end effector space-curve trajectory. More specifically, the invention is focused on end effector continuous space-curve trajectory tasks, and provides an error model taking into account of the influence of interpolation algorithm and joint linkage parameter error. This method selects key trajectory points on the ideal trajectory and by inverse solution converts them to the joint space, and performs interpolation; meanwhile the linkage parameter error taken into account to obtain the actual end effector position. The distance from the planned trajectory point to the ideal trajectory curve is used as the comprehensive error to reflect the deviation from the planned trajectory to the ideal trajectory. A simple and practical error model is obtained, which provides a theoretical basis for controlling the end effector-tracking accuracy.

### CROSS REFERENCE TO RELATED APPLICATION

This application is a national stage application of International application number PCT/CN2017/103080, filed Sep. 25, 2017, titled “An Error Modeling Method For End-Effector Space-Curve Trajectory Of Six Degree-of-Freedom Robots”, which claims the priority benefit of Chinese Patent Application No. 201710226520.8, filed on Apr. 9, 2017, which is hereby incorporated by reference in its entirety.

### TECHNICAL FIELD

This invention relates in general to the field of industrial robot end effector-tracking error analysis, and in particular, an end effector-tracking error model projecting the deviation between the planned trajectory and the ideal trajectory, simultaneously taking into account the influence of interpolation algorithm and joint linkage parameter error, providing a theoretical basis for controlling the robot end effector-tracking accuracy.

### BACKGROUND

As one of the important performance indexes of industrial robots, end effector-tracking accuracy has become an important focus for research and development. Modern end effector error control mainly adopts a closed-loop control method. Although using a closed-loop control algorithm can effectively improve the positioning and repetitive positioning accuracy, closed-loop control algorithm heavily depends on the accuracies of joint sensors and end effector sensor. The closed-loop control algorithm also greatly complicates robot structure and makes controlling tracking accuracy of continuous trajectory extremely difficult. For the planning of the end effector continuous trajectory, there are two types of approach; one is to interpolate in the operation space, the other is to interpolate in the joint space. In order to ensure the movement flexibility of each joint, researchers normally interpolate inverse solutions of characteristic trajectory points into joint space, with the characteristic trajectory points reflecting ideal continuous curve trajectory. This results in a great influence by interpolation algorithm parameter selection on end effector-tracking accuracy. Secondly, in the actual industrial robot system, the linkage parameter error caused by manufacturing and assembly also exerts a great influence on end effector-tracking accuracy. Thus, to control the robot end effector-tracking accuracy, it is necessary to take into account of the two factors. In order to compensate for the end effector movement trajectory error, to improve the tracking accuracy, and avoid the complexity and uncertainty engendered by real-time measurement of and real-time compensation, it is necessary to perform offline prediction of the tracking error in the trajectory planning process. Therefore, it is important to establish the robot end effector-tracking error model. In the process of establishing the error model, since the general practice is to take points at equal time intervals at the end effector position during planning, it remains to be solved as to how to take the points on the ideal trajectory and calculate differential, in order to faithfully reflect the deviation between the planned trajectory and the ideal trajectory. This application aims to provide solution to this key issue.

### SUMMARY

The invention discloses an error modeling method for end-effector space-curve trajectory of six degree-of-freedom (DOF) robot. The main feature of this method is that the interpolation algorithm and structural error are both taken into account in the modeling at the same time, and a concise and practical error model is provided for the continuous trajectory tracking of the robot end effector, so as to provide a theoretical basis for the tracking accuracy control.

The invention discloses an error modeling method for end effector space-curve trajectory of the six DOF robot, including the following steps:

1) selecting N trajectory points on the space-curve, wherein N is positive whole number and is determined by specific operational task, and obtaining displacement or angular displacement of each joint based on an inverse solution model;

2) selecting an interpolation algorithm and performing interpolation to obtain functional relationships between joint variables and time, wherein M joint variables are selected by taking a point every 20 milliseconds (ms), and wherein a total motion time obtained by the interpolation algorithm being T(s), M is T/0.02;

3) taking into account of the structural errors of each joint of the robot, obtaining positive solution to obtain M corresponding robot end effector trajectory points Q;

4) selecting point P on an ideal trajectory so that the points Q is on a normal line that passes the point P, therefore defining an trajectory error E as the distance between the point P and the point Q, so that the problem is transformed into solving the error E based on a known ideal space trajectory curve equation and coordinates of the point Q; wherein when E approaches infinitesimal, planned trajectory coincide with the ideal trajectory;

5) based on the curve equation, obtaining a tangent equation that passes the point P, calculating the coordinate of the point P, with the condition of PQ⊥PP₁ (P1 Is any point of the tangent line), so as to obtain the error E.

FIG. 1 shows the error diagram of the planned space-curve trajectory.

The invention is characterized by simultaneous adjustment to the interpolation algorithm operation and the error of each joint linkage structure. A closer to reality error model is established for the continuous trajectory tracking task of the end effector of the 6 DOF industrial robot, so as to provide a theoretical basis for the realization of trajectory tracking precision control.

### BRIEF DESCRIPTION OF THE DRAWINGS

FIG. 1 shows the error diagram of the planned space-curve trajectory.

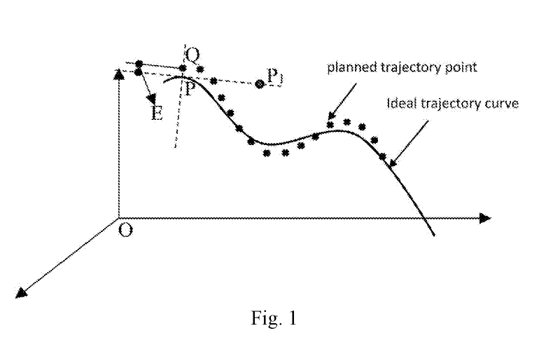

### DETAILED DESCRIPTION OF THE PREFERRED EMBODIMENTS

### Embodiment I

The step (1) of obtaining displacement or angular displacement of each joint is performed by:

Setting robot end effector operational task space-curve equation as following:

$$\{ \begin{matrix}F ( x , y , z ) = 0 \\ G ( x , y , z ) = 0\end{matrix}$$

Selecting the N trajectory points evenly on the curve, and obtaining the angular displacement θ of each joint of the robot by inverse solution;

The step (2) of performing interpolation for each joint variables is performed by: using an interpolation algorithm to interpolate the joint variables, and obtaining the functional relationship between the i joint variable and the motion time as follows:

θᵢ=fᵢ(t)

Taking a function value every 20 ms on a function curve obtained according to the above formula, so as to obtain M displacement values θᵢ of each joint, and calculate M corresponding trajectory points Q through the forward kinematics model;

The step (3) of calculating corresponding robot end effector trajectory points is performed as follows:

The robot end effector position being related to the displacement θᵢ of each joint, also being related to robot D-H linkage parameters, e.g., linkage length aᵢ, linkage twist angle αᵢ, joint distance dᵢ and joint angle θᵢ, therefore, the forward kinematics model of the robot is expressed as follows:

Pos=gₛₜ(θᵢ,aᵢ,αᵢ,dᵢ,θᵢ)

Furthermore, there being the robot linkage parameter errors from the process of manufacturing and assembly, and such errors being able to affect robot end effector positioning accuracy, known linkage parameters thus can be expressed as:

aᵢ+Δaᵢ,αᵢ+Δαᵢ,dᵢ+Δdᵢ,θᵢ+Δθᵢ,

respectively; when the structural errors of each joint of the robot are taken into account, the position of the robot end effector is expressed as:

Pos(actual)=gₛₜ(θᵢ,aᵢ+Δaᵢ,αᵢ+Δαᵢ,dᵢ+Δdᵢ,θᵢ+Δθᵢ)

wherein the joint angle θᵢ is obtained by interpolation, so that the actual position of the robot end effector is also affected by the interpolation algorithm; wherein by substituting the M joint angles θᵢ into the above equation, the M corresponding robot end effector trajectory points are obtained;

The step (4) of calculating error E is performed as follows:

Setting the point P as a point on an ideal trajectory, and Q is on the normal line passing P, the point P₁ is on tangent line passing the point P, thus PQ⊥PP₁, setting the spatial coordinates of each point as P (x₀, y₀, z₀) and P₁ (x₁, y₁, z₁), in order to faithfully reflect the deviation between the actual end effector trajectory and the ideal trajectory, the trajectory error E is defined as the distance between point P and point Q. As E approaches infinitesimal, the planned trajectory coincides with the ideal trajectory;

wherein the equation of the tangent line passing the point P is obtained from a space-curve function as follows:

$$\{ \begin{matrix}\frac{\partial F}{\partial x} {\vert}_{( {x}_{0} , {y}_{0} , {z}_{0} )} ( x - {x}_{0} ) + \frac{\partial F}{\partial y} {\vert}_{( {x}_{0} , {y}_{0} , {z}_{0} )} ( y - {y}_{0} ) + \frac{\partial F}{\partial z} {\vert}_{( {x}_{0} , {y}_{0} , {z}_{0} )} ( z - {z}_{0} ) = 0 \\ \frac{\partial G}{\partial x} {\vert}_{( {x}_{0} , {y}_{0} , {z}_{0} )} ( x - {x}_{0} ) + \frac{\partial G}{\partial y} {\vert}_{( {x}_{0} , {y}_{0} , {z}_{0} )} ( y - {y}_{0} ) + \frac{\partial G}{\partial z} {\vert}_{( {x}_{0} , {y}_{0} , {z}_{0} )} ( z - {z}_{0} ) = 0\end{matrix}$$

Take x−x₀=Δx, y−y₀ and z−z₀ is obtained from the above formula, satisfying the following conditions:

$$\{ \begin{matrix}F ( x , y , z ) = 0 \\ G ( x , y , z ) = 0 \\ ( x - {x}_{0} ) ( X - {x}_{0} ) + ( y - {y}_{0} ) ( Y - {y}_{0} ) + ( z - {z}_{0} ) ( Z - {z}_{0} ) = 0\end{matrix}$$

Finally, solving the position of point P (x₀,y₀,z₀) from the above equations, obtaining the error E as follows:

E=|\vec{PQ}|=\sqrt{(X−x₀)²+(Y−y₀)²+(Z−z₀)²}.

What is claimed is:

1. An error modeling method for six degree-of-freedom robot end effector space-curve trajectory, comprising the following steps:
(1) selecting N trajectory points on the space-curve, wherein N is determined by specific operational task, and obtaining displacement or angular displacement of each joint based on an inverse solution model;
(2) selecting an interpolation algorithm and performing interpolation to obtain functional relationships between joint variables and time, wherein M joint variables are selected by taking a point every 20 milliseconds (ms), and wherein a total motion time obtained by the interpolation algorithm being T(s), M is T/0.02;
(3) taking into account of the structural errors of each joint of the robot, obtaining positive solution to obtain M corresponding robot end effector trajectory points Q;
(4) selecting point P on an ideal trajectory so that the points Q is on a normal line that passes the point P, therefore defining an trajectory error E as the distance between the point P and the point Q, so that the problem is transformed into solving the error E based on a known ideal space trajectory curve equation and coordinates of the point Q; wherein when E approaches infinitesimal, planned trajectory coincide with the ideal trajectory; and
(5) based on the curve equation, obtaining a tangent equation that passes the point P, calculating the coordinate of the point P, with the condition of PQ⊥PP₁ (P₁ Is any point of the tangent line), so as to obtain the error E.

2. A method according to claim 1, wherein:
the step (1) of obtaining displacement or angular displacement of each joint is performed by:
setting robot end effector operational task space-curve equation as following:
$$\{ \begin{matrix}F ( x , y , z ) = 0 \\ G ( x , y , z ) = 0\end{matrix}$$
selecting the N trajectory points evenly on the curve, and obtaining the angular displacement θ of the each joint of the robot by inverse solution;
the step (2) of performing interpolation for each joint variables is performed by:
using an interpolation algorithm to interpolate the joint variables, and obtaining the functional relationship between the i joint variable and the motion time as follows:
θᵢ=fᵢ(t)
taking a function value every 20 ms on a function curve obtained according to the above formula, so as to obtain M displacement values θᵢ of each joint, and calculate M corresponding trajectory points Q through the forward kinematics model;
the step (3) of calculating corresponding robot end effector trajectory points is performed as follows:
the robot end effector position being related to the displacement θᵢ of each joint, also being related to robot D-H linkage parameters, e.g., linkage length a₁, linkage twist angle αᵢ, joint distance dᵢ and joint angle θᵢ, therefore, the forward kinematics model of the robot is expressed as follows:
Pos=gₛₜ(θᵢ,aᵢ,αᵢ,dᵢ,θᵢ)
furthermore, there being the robot linkage parameter errors from the process of manufacturing and assembly, and such errors being able to affect robot end effector positioning accuracy, known linkage parameters thus can be expressed as aᵢ+Δaᵢ,αᵢ+Δαᵢ,dᵢ+Δdᵢ,θᵢ,+Δθᵢ, respectively; when the structural errors of each joint of the robot are taken into account, the position of the robot end effector is expressed as:
Pos(actual)=gₛₜ(θᵢ,aᵢ+Δaᵢ,αᵢ+Δαᵢ,dᵢ+Δdᵢ,θᵢ+Δθᵢ)
wherein the joint angle θᵢ is obtained by interpolation, so that the actual position of the robot end effector is also affected by the interpolation algorithm; wherein by substituting the M joint angles θᵢ into the above equation, the M corresponding robot end effector trajectory points are obtained;
the step (4) of calculating error E is performed as follows:
setting the point P as a point on an ideal trajectory, and Q is on the normal line passing P, the point P₁ is on tangent line passing the point P, thus PQ⊥PP₁, setting the spatial coordinates of each point as P (x₀, y₀, z₀) and P₁ (x₁, y₁, z₁), in order to faithfully reflect the deviation between the actual end effector trajectory and the ideal trajectory, the trajectory error E is defined as the distance between point P and point Q. As E approaches infinitesimal, the planned trajectory coincides with the ideal trajectory;
wherein the equation of the tangent line passing the point P is obtained from a space-curve function as follows:
$$\{ \begin{matrix}\frac{\partial F}{\partial x} {\vert}_{( {x}_{0} , {y}_{0} , {z}_{0} )} ( x - {x}_{0} ) + \frac{\partial F}{\partial y} {\vert}_{( {x}_{0} , {y}_{0} , {z}_{0} )} ( y - {y}_{0} ) + \frac{\partial F}{\partial z} {\vert}_{( {x}_{0} , {y}_{0} , {z}_{0} )} ( z - {z}_{0} ) = 0 \\ \frac{\partial G}{\partial x} {\vert}_{( {x}_{0} , {y}_{0} , {z}_{0} )} ( x - {x}_{0} ) + \frac{\partial G}{\partial y} {\vert}_{( {x}_{0} , {y}_{0} , {z}_{0} )} ( y - {y}_{0} ) + \frac{\partial G}{\partial z} {\vert}_{( {x}_{0} , {y}_{0} , {z}_{0} )} ( z - {z}_{0} ) = 0\end{matrix}$$
take x−x₀=Δx, y−y₀ and z−z₀ is obtained from the above formula, satisfying the following conditions:
$$\{ \begin{matrix}F ( x , y , z ) = 0 \\ G ( x , y , z ) = 0 \\ ( x - {x}_{0} ) ( X - {x}_{0} ) + ( y - {y}_{0} ) ( Y - {y}_{0} ) + ( z - {z}_{0} ) ( Z - {z}_{0} ) = 0\end{matrix}$$
solving the position of point P (x₀,y₀,z₀) from the above equations, obtaining the error E as follows:
E=|\vec{PQ}|=\sqrt{(X−x₀)²+(Y−y₀)²+(Z−z₀)²}.
